(19) United States
(12) Patent Application Publication
(10) Pub. No.: US 2021/0266456 A1
(43) Pub. Date: Aug. 26, 2021

(54) IMAGE CAPTURE CONTROL METHOD, IMAGE CAPTURE CONTROL DEVICE, AND MOBILE PLATFORM

(71) Applicant: SZ DJI TECHNOLOGY CO., LTD., Shenzhen (CN)

(72) Inventors: Wen ZOU, Shenzhen (CN); Pan HU, Shenzhen (CN)

(73) Assignee: SZ DJI TECHNOLOGY CO., LTD., Shenzhen (CN)

(21) Appl. No.: 17/317,887

(22) Filed: May 11, 2021

Related U.S. Application Data
(63) Continuation of application No. PCT/CN2019/081518, filed on Apr. 4, 2019.

(51) Int. Cl. H04N 5/232; H04N 5/217

(52) U.S. Cl. CPC H04N 5/23222; H04N 5/23219; H04N 5/217

(57) ABSTRACT

The present disclosure provides an image capture control method, including: in a process of changing a posture of the image capture device, obtaining a plurality of reference images captured by the image capture device; performing saliency detection on each reference image to determine a salient region in each reference image; determining an evaluation parameter of each reference image based on the salient region in each reference image and a preset image composition rule; determining a target image among the plurality of reference images based on the evaluation parameters; and setting, based on a posture of the image capture device in capture of the target image, a posture of the image capture device in image capture. Embodiments of the present disclosure help ensure that an image obtained by automatic shooting meets an aesthetic need of a user while automatic shooting of the image capture device is implemented.

### RELATED APPLICATIONS

This application is a continuation application of PCT application No. PCT/CN2019/081518, filed on Apr. 4, 2019, and the content of which is incorporated herein by reference in its entirety.

### TECHNICAL FIELD

The present disclosure relates to the image capture field, and in particular, to an image capture control method, an image capture control device, and a mobile platform.

### BACKGROUND

Currently, for most cameras, the shooting processes need to be manually completed by users. Some cameras may provide assistance to users, but the assistance provided is only limited to very basic information, such as displaying horizontal lines and displaying face position frames. Eventually, users still need to perform operations manually to determine appropriate framing based on their aesthetic needs to complete the shooting.

Although some cameras can perform automatic shooting, the aesthetic effect of framing is not considered, and the final photos often fail to meet the aesthetic needs of users.

### SUMMARY

The present disclosure provides an image capture control method, an image capture control device, and a mobile platform, to ensure that an image obtained by automatic shooting meets the aesthetic needs of a user while an image capture device implements automatic shooting.

According to a first aspect, some exemplary embodiments of the present disclosure provide an image capture control method, including: obtaining, in a posture changing process of an image capture device, a plurality of reference images captured by the image capture device; for each of the plurality of reference images, determining a salient region by performing saliency detection, and determining at least one evaluation parameter based on the salient region and a preset image composition rule; determining a target image among the plurality of reference images based on the at least one evaluation parameter of each of the plurality of reference images; and setting, based on a first posture of the image capture device when capturing the target image, a second posture of the image capture device for capturing other images.

According to a second aspect, some exemplary embodiments of the present disclosure provide an image capture control device, including: at least one storage medium storing a set of instructions for image capture control; and at least one processor in communication with the at least one storage medium, where during operation, the at least one processor executes the set of instructions to: obtain, in a posture changing process of the image capture device, a plurality of reference images captured by the image capture device; for each of the plurality of reference images: determine a salient region by performing saliency detection; determine at least one evaluation parameter based on the salient region and a preset image composition rule; determine a target image among the plurality of reference images based on the at least one evaluation parameter of each of the plurality of reference images; and set, based on a first posture of the image capture device in when capture capturing of the target image, a second posture of the image capture device in for capturing other images.

According to a third aspect, some exemplary embodiments of the present disclosure provide a mobile platform, including: a body; an image capture device to capture at least one image; and an image capture control device, including: at least one storage medium storing a set of instructions for image capture control; and at least one processor in communication with the at least one storage medium, where during operation, the at least one processor executes the set of instructions to: obtain, in a posture changing process of the image capture device, a plurality of reference images captured by the image capture device; for each of the plurality of reference images, determine a salient region by performing saliency detection; determine at least one evaluation parameter based on the salient region and a preset image composition rule; determine a target image among the plurality of reference images based on the at least one evaluation parameter of each of the plurality of reference images; and set, based on a first posture of the image capture device in when capture capturing of the target image, a second posture of the image capture device in for capturing other images.

As can be seen from the technical solutions provided by the certain exemplary embodiments of the present disclosure, the image capture control device may automatically select a target image from a plurality of reference images, and then may automatically adjust the posture based on the posture for capturing of the target image, so as to capture an image that meets an aesthetic need of a user. It can also be ensured that an image obtained by automatic shooting meets the aesthetic need of the user while automatic shooting of the image capture device is implemented, and the user does not need to manually adjust the posture. This helps achieve a higher degree of automatic shooting.

### BRIEF DESCRIPTION OF THE DRAWINGS

To clearly describe the technical solutions in the embodiments of the present disclosure, the following briefly describes the accompanying drawings used for describing some exemplary embodiments. Apparently, the accompanying drawings in the following description show merely some exemplary embodiments of the present disclosure, and a person of ordinary skill in the art may still derive other drawings from these accompanying drawings without creative efforts.

FIG. 1 is a schematic flowchart of an image capture control method according to some exemplary embodiments of the present disclosure;

FIG. 2 is a schematic flowchart of performing saliency detection on each reference image to determine a salient region in each reference image according to some exemplary embodiments of the present disclosure;

FIG. 3 is a schematic flowchart of determining an evaluation parameter(s) of each reference image according to some exemplary embodiments of the present disclosure;

FIG. 4 is a schematic flowchart of determining an evaluation parameter(s) of a salient region based on each image composition rule according to some exemplary embodiments of the present disclosure;

FIG. 5 is another schematic flowchart of determining an evaluation parameter(s) of a salient region based on each image composition rule according to some exemplary embodiments of the present disclosure;

FIG. 6 is a schematic flowchart of an image capture control method according to some exemplary embodiments of the present disclosure;

FIG. 7 is a schematic flowchart of eliminating errors caused by lens distortion and the so called “jello” effect of an image capture device for a reference image according to some exemplary embodiments of the present disclosure;

FIG. 8 is a schematic flowchart of an image capture control method according to some exemplary embodiments of the present disclosure;

FIG. 9 is a schematic diagram of an image capture control device according to some exemplary embodiments of the present disclosure; and

FIG. 10 is a schematic structural diagram of a mobile platform according to some exemplary embodiments of the present disclosure.

### DETAILED DESCRIPTION

The following describes the technical solutions in some exemplary embodiments of the present disclosure with reference to the accompanying drawings. Apparently, the described exemplary embodiments are merely some rather than all of the embodiments of the present disclosure. All other embodiments that a person of ordinary skill in the art may obtain without creative efforts based on the embodiments of the present disclosure shall fall within the scope of protection of the present disclosure. In addition, in absence of conflicts, the following embodiments and features thereof may be combined with each other.

Some exemplary embodiments of the present disclosure provide a mobile platform, where the mobile platform includes a body, an image capture device, and an image capture control device. The image capture device may be configured to capture an image. The image capture control device may obtain, in a process of changing a posture of the image capture device, a plurality of reference images captured by the image capture device; perform saliency detection on each reference image to determine a salient region in each reference image; determine an evaluation parameter(s) of each reference image based on the salient region in each reference image and a preset image composition rule; determine a target image among the plurality of reference images based on the evaluation parameters; and set, based on a posture of the image capture device when capturing the target image, a posture of the image capture device for capturing images.

Therefore, the image capture control device may automatically select the target image from the plurality of reference images, and then may automatically adjust the posture of the image capture device based on the posture for capturing the target image, to capture an image that meets an aesthetic need of a user. It may also be ensured that an image obtained by automatic shooting meets the aesthetic need of the user while automatic shooting of the image capture device is implemented, and the user does not need to manually adjust the posture. This helps achieve a higher degree of automatic shooting.

In some exemplary embodiments, the mobile platform may further include a communications apparatus, and the communications apparatus may be configured to provide communication between the mobile platform and an external device, where the communications may be wired communication or wireless communication, and the external device may be a remote control or a terminal such as a mobile phone, a tablet computer, or a wearable device.

In some exemplary embodiments, the mobile platform may be one of an unmanned aerial vehicle, an unmanned vehicle, a handheld device, and a mobile robot.

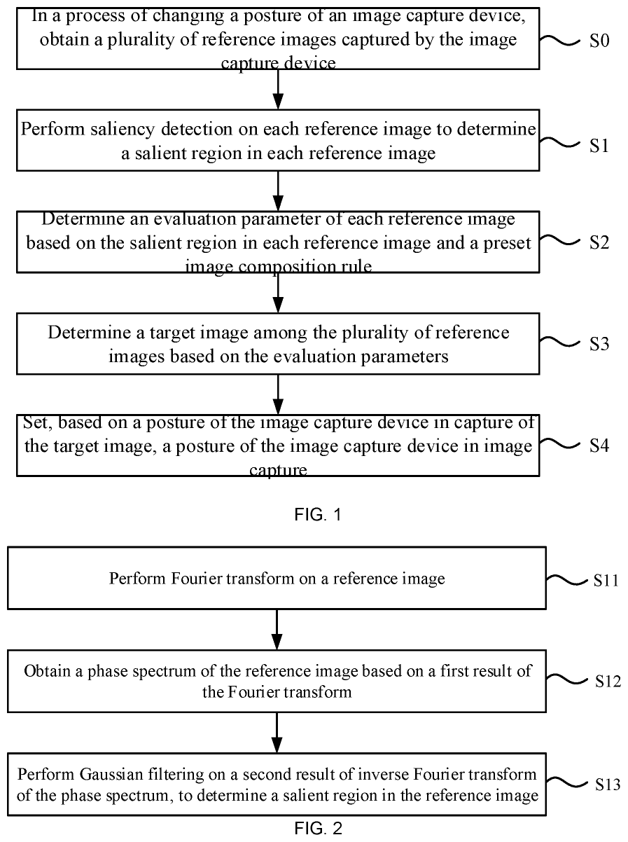

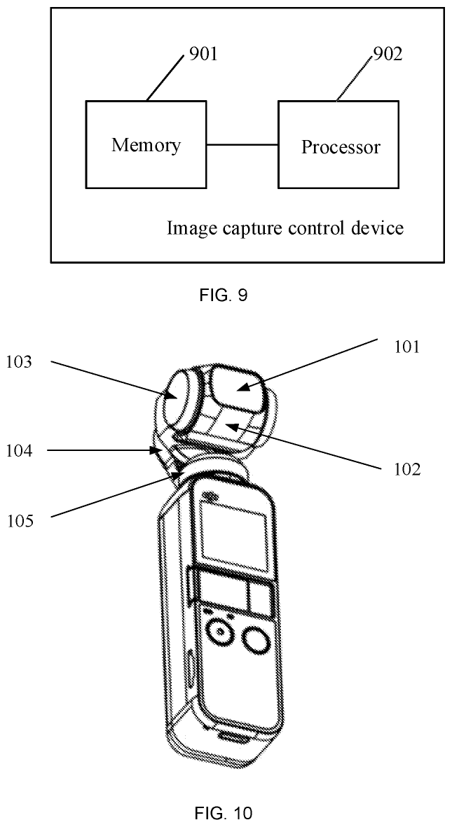

FIG. 1 is a schematic flowchart of an image capture control method according to some exemplary embodiments of the present disclosure. The method may be executed by an image capture control device as shown in FIG. 9, or a mobile platform as shown in FIG. 10 of the present disclosure. For example, the method may be stored as a set of instructions in a storage medium of the image capture control device or the mobile platform. A processor of the image capture control device or the mobile platform may, during operation, read and execute the set of instructions to perform the following steps of the method. As shown in FIG. 1, the image capture control method may include the following steps.

Step S0: In a process of changing a posture of an image capture device, obtain a plurality of reference images captured by an image capture device.

Step S1: Perform saliency detection on each reference image to determine a salient region in each reference image.

Step S2: Determine an evaluation parameter(s) of each reference image based on the salient region in each reference image and a preset image composition rule.

Step S3: Determine a target image among the plurality of reference images based on the evaluation parameters of the plurality of reference images.

Step S4: Set, based on a posture of the image capture device when capturing the target image, a posture of the image capture device for capturing other images.

In some exemplary embodiments, the image capture device may be first oriented toward a target region, where the target region may be a region set by a user, or may be a region generated automatically by an image capture control device. Then the posture of the image capture device may be adjusted. For example, one or more posture angles (which may include a roll angle, a yaw angle, and a pitch angle) of the image capture device may be adjusted within a preset angle range, or a position of the image capture device in one or more directions may be adjusted within a preset distance range, so that the image capture device changes the posture.

In addition, in the process of changing the posture, a reference image may be obtained. For example, every time the posture is changed, a reference image may be obtained. Therefore, the image capture device may obtain a plurality of reference images, and then saliency detection is performed on the reference images to determine salient regions in the reference images.

The operation of changing the posture of the image capture device may be performed manually by a user, or may be performed automatically by the image capture device.

In some exemplary embodiments, a reference image may be obtained, where the reference image is an image captured by the image capture device before a shutter is pressed. The reference image and an image captured by the image capture device after the shutter is pressed are different in a plurality of aspects, for example, different in degrees of fineness of processing by the image capture device and different in resolutions. In some exemplary embodiments, the reference image may be provided to the user for preview.

Saliency detection specifically refers to visual saliency detection. Saliency detection may simulate human visual characteristics by using an intelligent algorithm, and extract a region of human interest from the reference image as a salient region. In one reference image, one salient region may be determined, or a plurality of salient regions may be determined, specifically depending on an actual situation.

Since the salient region is a region of interest to the human eyes, and the preset image composition rule meets certain aesthetic standards, the evaluation parameter(s) of the salient region in the reference image may be determined based on the preset image composition rule, and based on the evaluation parameter(s), it may be determined whether the reference image meets the aesthetic needs of human beings. The evaluation parameter(s) may be a numerical value(s), and the numerical value(s) may be displayed in association with the reference image, for example, displayed in the reference image for the user's reference, and specifically may be displayed in the reference image as a score.

Further, based on the evaluation parameter(s), the posture of the image capture device in image capture may be set.

In some exemplary embodiments, the evaluation parameter(s) may represent the aesthetic needs of human beings. In this case, based on the evaluation parameter(s), an image that meets the aesthetic needs of human beings may be determined among the plurality of reference images as the target image, and then the posture of the image capture device for image capture may be set based on the posture of the image capture device for obtaining the target image. For example, the posture of the image capture device in image capture is set to the posture for capturing the target image to ensure that the captured image(s) can meet the aesthetic needs of human beings.

It should be noted that the target image may be one reference image or may be a plurality of reference images. In an example where the evaluation parameter(s) is a numerical value, a reference image with a largest numerical value may be selected as the target image, or a reference image(s) with a numerical value greater than a first preset value may be selected as the target image(s).

In some exemplary embodiments, the posture of the image capture device for image capture may also be adjusted to a posture that has a specific relationship (for example, symmetry or rotation) with the posture of the image capture device when obtaining the target image, so that the captured image may meet specific needs.

It is noted that the posture of the image capture device for taking further images is set based on the posture of the image capture device when obtaining the target image. That is to say, the posture of the image capture device for taking further images may be set as identical to, symmetrical to, or at an angle to the posture of the image capture device when obtaining the target image, or may be set as having any other relationship with the posture of the image capture device when obtaining the target image, which is not limited herein.

According to the foregoing exemplary embodiments, the image capture control device may automatically adjust the posture of the image capture device for image capture based on the evaluation parameter(s) of the salient region in each reference image based on a preset image composition rule, so as to capture an image that meets an aesthetic need of the user. This may also ensure that an image obtained by automatic shooting meets the aesthetic needs of the user while automatic shooting of the image capture device is implemented, and the user does not need to manually adjust the posture. This helps achieve a higher degree of automatic shooting.

FIG. 2 is a schematic flowchart of performing saliency detection on each reference image to determine a salient region in each reference image according to some exemplary embodiments of the present disclosure. As shown in FIG. 2, the performing of the saliency detection on each reference image to determine the salient region in each reference image may include:

Step S11: Perform Fourier transform on each reference image.

Step S12: Obtain a phase spectrum of each reference image based on a first result of the Fourier transform.

Step S13: Perform Gaussian filtering on a second result of inverse Fourier transform of the phase spectrum to determine the salient region in each reference image.

In some exemplary embodiments, an image evaluation parameter(s), such as a pixel value, denoted as I(x,y), may be determined for a pixel located at coordinates (x,y) in the reference image, and then Fourier transform is performed for each pixel in the reference image. The calculation formula is as follows:

f(x,y)=F(I(x,y))

Further, for the first result f (x,y) of the Fourier transform, the phase spectrum p(x,y) of the reference image may be obtained, and the calculation formula is as follows:

p(x,y)=P(f(x,y))

Then Gaussian filtering is performed on the second result of inverse Fourier transform of the phase spectrum, where p(x,y) may be used as a power to construct an exponential expression e^{i,p(x,y)} of e first, and Gaussian filtering is performed on an inverse Fourier transform result of the exponential expression, to obtain a saliency evaluation parameter(s) sM(x y) of each pixel in the reference image. A calculation formula is as follows:

sM(x,y)=g(x,y)*∥F⁻¹[e^{i,p(x,y)}]∥².

Based on the saliency evaluation parameter(s) of the pixel, whether the pixel belongs to the salient region may be determined. For example, if the saliency evaluation parameter(s) is a saliency numerical value, the saliency numerical value may be compared with a second preset value, and pixels whose saliency numerical values are greater than the second preset value may be included into a salient region, so that the salient region is determined.

It should be noted that the steps in the exemplary embodiments shown in FIG. 2 are only one possible implementation for determining the salient region. A manner for determining the salient region in the present disclosure may include, but is not limited to, the steps in the exemplary embodiments shown in FIG. 2. For example, alternatively, the salient region may be determined based on lower-compression (LC) algorithm, or the salient region may be determined based on a high-compression (HC) algorithm, or the salient region may be determined based on an Aho-Corasick (AC) algorithm, or the salient region may be determined based on a frequency tuned (FT) algorithm. The saliency detection may include detection of a human face or detection of an object, and a specific manner thereof may be selected based on a requirement.

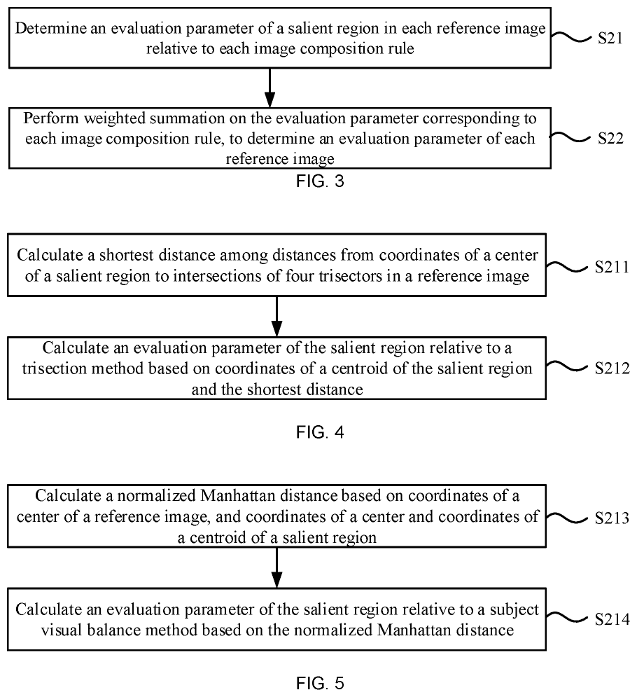

FIG. 3 is a schematic flowchart of determining an evaluation parameter(s) of a salient region based on a preset image composition rule for each reference image according to some exemplary embodiments of the present disclosure. As shown in FIG. 3, the preset image composition rule includes at least one image composition rule, and the determining of the evaluation parameter(s) of the salient region based on the preset image composition rule for each reference image may include:

Step S21: Determine a first evaluation parameter(s) of the salient region in each reference image based on each image composition rule.

Step S22: Perform weighted summation on the first evaluation parameter(s) corresponding to each image composition rule to determine the evaluation parameter(s) of the salient region based on the preset image composition rule.

In some exemplary embodiments, an aesthetic view of each image composition rule may be different. In some exemplary embodiments, weighted summation may be performed on the first evaluation parameters corresponding to various image composition rules to determine the evaluation parameter(s) of the salient region based on the preset image composition rule. The aesthetic views the image composition rules may be comprehensively considered, so that the evaluation parameter(s) of the salient region based on the preset image composition rule is obtained, and then the target image is determined based on the obtained evaluation parameter(s), so that the determined target image may meet the requirements of a variety of aesthetic views. Even if the aesthetic views of different users are not the same, the target image may still meet the aesthetic needs of different users.

In some exemplary embodiments, the image composition rule may include at least one of the following:

A rule of thirds, a subject visual balance method, a golden section method, and a center symmetry method.

The following uses the rule of thirds and the subject visual balance method as examples to illustrate some exemplary embodiments of the present disclosure.

FIG. 4 is a schematic flowchart of determining a first evaluation parameter(s) of a salient region based on each image composition rule according to some exemplary embodiments of the present disclosure. As shown in FIG. 4, the image composition rule may include the rule of thirds, and the determining of the first evaluation parameter(s) of the salient region based on each image composition rule may include:

Step S211: Calculate (or determine) a shortest distance among distances from coordinates of a center of the salient region to intersections of four trisectors in the reference image.

Step S212: Calculate a first evaluation parameter(s) of the salient region based on the rule of thirds with coordinates of a centroid of the salient region and the shortest distance.

In some exemplary embodiments, the rule of thirds imaginarily divides the reference image into nine parts by two equally spaced lines (i.e., first trisection-lines) along a length direction of the reference image and two equally spaced lines (i.e., second trisection-lines) along a width direction of the reference image. The four trisection-lines intersect to form four intersections.

If the salient region in the reference image is located near an intersection or distributed along a trisector, it can be determined that composition of the salient region in the reference image conforms to the rule of thirds. If the salient region in the reference image conforms at a higher degree to the rule of thirds, for example, if the salient region is closer to an intersection, the evaluation parameter(s) of the salient region with respect to the rule of thirds would be larger.

In some exemplary embodiments, the first evaluation parameter(s) S_{RT} of the salient region with respect to the rule of thirds may be calculated by using the following formula:

$${S}_{R T} = \frac{1}{{\sum }_{i} M ( {S}_{i} )} {\sum }_{i} M ( {S}_{i} ) {e}^{- \frac{{D}^{2} ( {S}_{i} )}{2 {σ}_{1}} ,}$$

$$where D ( {S}_{i} ) = {min}_{j = 1 , 2 , 3 , 4} {d}_{M} ( C ( {S}_{i} ) , {G}_{j} ) ,$$

Gⱼ represents a jth intersection, C(Sᵢ) represents coordinates of a center of an ith salient region Sᵢ in the reference image, d_{M} (C(Sᵢ),Gⱼ) represents a distance from coordinates of a center of a salient region in an ith reference image to the jth intersection, D(Sᵢ) is a shortest distance in d_{M} (C(Sᵢ),Gⱼ), M(S) represents coordinates of a centroid of the ith salient region Sᵢ in the reference image, and σ₁ is a variance control factor and may be set as needed. The reference image may include n salient regions, where i≤n, and summation may be performed from i=1 to i=n.

According to the calculation in some exemplary embodiments, a relationship between all the salient regions in the reference image as a whole and the intersection of the trisectors may be considered based on a relationship between the shortest distance from the center of the salient region to the intersection of the trisectors and the centroid of the salient region, and then the first evaluation parameter(s) S_{RT} of the salient region with respect to the rule of thirds may be determined. The closer all the salient regions in the reference image as a whole to the intersection(s) of the trisectors, the larger S_{RT}. Correspondingly, the farther all the salient regions in the reference image as a whole away from the intersection(s) of the trisectors, the smaller S_{RT}.

FIG. 5 is a schematic flowchart of determining a first evaluation parameter(s) of a salient region based on each image composition rule according to some exemplary embodiments of the present disclosure. As shown in FIG. 5, the image composition rule may include the subject visual balance method, and the determining of the first evaluation parameter(s) of the salient region based on each image composition rule may include:

Step S213: Calculate a normalized Manhattan distance based on coordinates of a center of the reference image and coordinates of a center and coordinates of a centroid of the salient region.

Step S214: Calculate a first evaluation parameter(s) of the salient region based on the subject visual balance method with the normalized Manhattan distance.

In some exemplary embodiments, if content in the salient region in the reference image is evenly distributed around a center point of the reference image, it can be determined that composition of the salient region in the reference image conforms to the subject visual balance method. If the salient region in the reference image conforms at a higher degree to the subject visual balance method, for example, the more evenly the content in the salient region is distributed around the center point of the reference image, the larger the first evaluation parameter(s) of the salient region based on the subject visual balance method.

In some exemplary embodiments, the first evaluation parameter(s) S_{VB} of the salient region based on the subject visual balance method may be calculated by using the following formula:

$${S}_{V B} = {e}^{- \frac{{d}_{VB}^{2}}{2 {σ}_{2}}} , \\ where {d}_{V B} = {d}_{M} ( C , \frac{1}{{\sum }_{i} M ( {S}_{i} )} {\sum }_{i} M ( {S}_{i} ) C ( {S}_{i} ) ) ,$$

C represents the coordinates of the center of the reference image, C (Sᵢ) represents coordinates of a center of an ith salient region Sᵢ in the reference image, M(Sⁱ) represents coordinates of a centroid of the ith salient region Sᵢ in the reference image, d_{M} represents calculation of the normalized Manhattan distance, and σ₂ is a variance control factor and may be set as needed. The reference image may include n salient regions, i≤n, and summation may be performed from i=1 to i=n.

According to the calculation in some exemplary embodiments, coordinates of a center of all the salient regions as a whole in the reference image may be determined based on relationships between coordinates of centers and coordinates of centroids of all the salient regions, then distribution of all the salient regions based on the center of the reference image may be determined based on a relationship between the center of all the salient regions as a whole and the center of the reference image, and then the first evaluation parameter(s) S_{VB} of the salient region based on the subject visual balance method is determined.

In some exemplary embodiments, for example, the preset image composition rule may include two image composition rules: the rule of thirds and the subject visual balance method. After the first evaluation parameter(s) S_{RT} of the salient region based on the rule of thirds is determined, and the first evaluation parameter(s) S_{VB} of the salient region based on the subject visual balance method is determined, weighted summation may be performed on S_{RT} and S_{VB} to obtain the evaluation parameter(s) S_{A} of the salient region based on the preset image composition rule:

$${S}_{A} = \frac{{ω}_{R T} {S}_{R T} + {ω}_{VB} {S}_{VB}}{{ω}_{R T} + {ω}_{VB}} ,$$

where ω_{RT} is a weight of S_{RT}, and ω_{VB} is a weight of S_{VB}.

In some exemplary embodiments, a user may preset the weight corresponding to the first evaluation parameter(s) S_{RT} of the rule of thirds and the weight corresponding to the first evaluation parameter(s) S_{VB} of the subject visual balance method to meet an aesthetic need of the user.

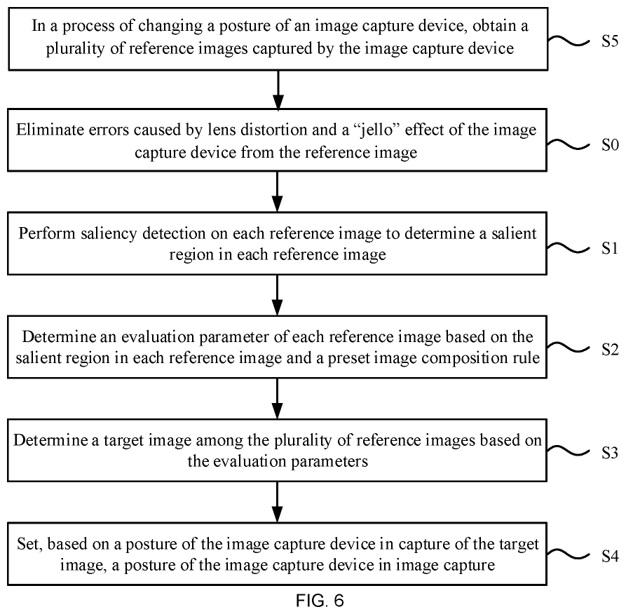

FIG. 6 is a schematic flowchart of another image capture control method according to some exemplary embodiments of the present disclosure. As shown in FIG. 6, before performing the saliency detection on each reference image, the method may further include:

Step S5: Eliminate errors caused by lens distortion and a “jello” effect of the image capture device from the reference image.

When a lens (such as a fisheye lens) of the image capture device obtains a reference image, there may be a nonlinear distortion effect at an edge of the reference image, causing some objects in the reference image to be different from objects in an actual scene (such as differences in shapes). Since the salient region is mainly a region containing an object. When the object in the reference image is different from the corresponding object in the actual scene, the difference may have a negative effect on accurately determining the salient region.

In addition, if the shutter of the image capture device is a rolling shutter, when the image capture device obtains a reference image, and an object in the reference image moves or vibrates rapidly relative to the image capture device, the content in the reference image obtained by the image capture device may have a problem such as tilting, partial exposure, or ghosting. This problem is referred to as a “jello” effect, which may also cause some objects in the reference image to be different from the corresponding objects in the actual scene(s) (such as differences in shapes). This may also have a negative effect on accurately determining the salient region.

In some exemplary embodiments, before the saliency detection is performed on each reference image, the errors caused by the lens distortion and the “jello” effect of the image capture device are eliminated from the reference image first, so that the salient region may be accurately determined subsequently.

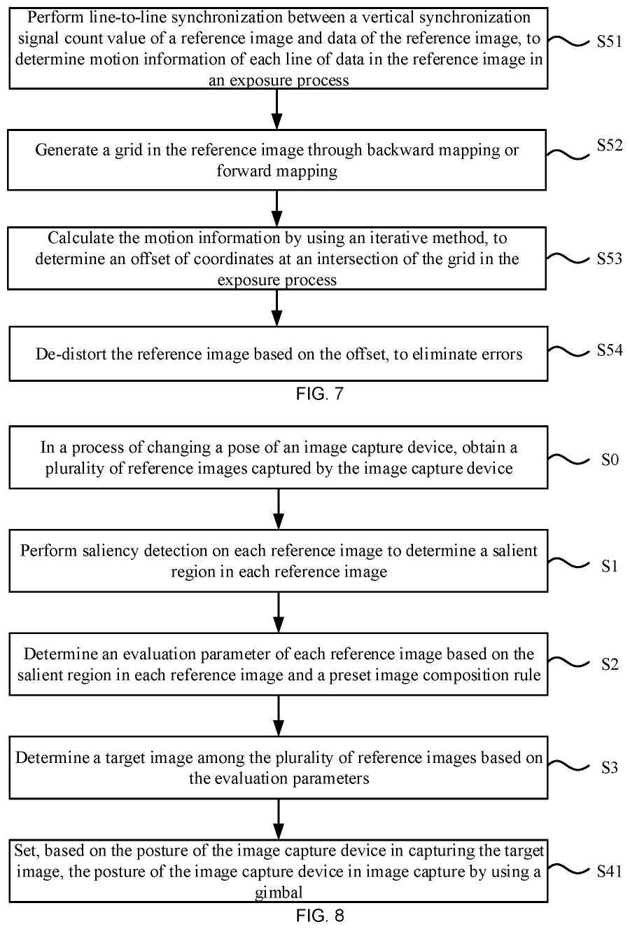

FIG. 7 is a schematic flowchart of eliminating errors caused by lens distortion and a “jello” effect of the image capture device from the reference image according to some exemplary embodiments of the present disclosure. As shown in FIG. 7, the eliminating of the errors caused by lens distortion and the “jello” effect of the image capture device from the reference image may include:

Step S51: Perform line-to-line synchronization between a vertical synchronization signal count value of the reference image and data of the reference image to determine motion information of each line of data in the reference image in an exposure process.

Step S52: Generate a grid in the reference image through backward mapping or forward mapping.

Step S53: Calculate the motion information by using an iterative method to determine an offset in coordinates at an intersection of the grid in the exposure process.

Step S54: De-distort (e.g., dewarp) the reference image based on the offset to eliminate the errors.

In some exemplary embodiments, a difference between the object in the reference image and the corresponding object in the actual scene caused by nonlinear distortion is mainly present in a lens radial direction and a lens tangential direction; a difference between the object in the reference image and the object in the actual scene caused by the “jello” effect is mainly present in a row direction of a photoelectric sensor array in the image capture device (the photoelectric sensor array uses a line-by-line scanning manner for exposure).

Either of the foregoing differences is essentially an offset of the object in the reference image relative to the corresponding object in the actual scene, and the offset may be equivalent to motion of the object in the exposure process. Therefore, the offset may be obtained by using motion information of data in the reference image in the exposure process.

In some exemplary embodiments, line-to-line synchronization is performed between the vertical synchronization signal count value of the reference image and the data of the reference image, so as to determine a motion evaluation parameter(s) of each line of data in the reference image in the exposure process; then the grid is generated in the reference image through backward mapping or forward mapping; the motion information is calculated by using the iterative method, so that the offset in the coordinates at the intersection of the grid in the exposure process can be determined; on this basis, the offset of the coordinates at the intersection of the grid in the reference image represented by the grid in the exposure process may be obtained, and the offset may indicate an offset of an object in a corresponding position relative to an object in the actual scene in the exposure process; therefore, dewarping may be performed based on the offset to eliminate the errors caused by the lens distortion and the “jello” effect.

FIG. 8 is a schematic flowchart of an image capture control method according to some exemplary embodiments of the present disclosure. As shown in FIG. 8, the setting, based on a posture of the image capture device in obtaining the target image, of the posture of the image capture device in image capture may include:

Step S41: Set, based on the posture of the image capture device when obtaining the target image, the posture of the image capture device in image capture by using a gimbal.

In some exemplary embodiments, the posture of the image capture device in image capture may be set by using the gimbal.

In some exemplary embodiments, a target image may be determined among the plurality of reference images based on the evaluation parameters; and based on a target posture of the image capture device in obtaining the target image, the posture of the image capture device in image capture may be set by using the gimbal.

In some exemplary embodiments, the gimbal may include at least one of the following:

a single-axis gimbal, a two-axis gimbal, or a three-axis gimbal.

In some exemplary embodiments, a stabilization manner of the gimbal may include at least one of the following:

mechanical stabilization, electronic stabilization, or hybrid mechanical and electronic stabilization.

Corresponding to some exemplary embodiments of the image capture control method, the present disclosure further provides some exemplary embodiments of an image capture control device.

As shown in FIG. 9, the image capture control device provided by some exemplary embodiments of the present disclosure may include at least one memory 901 and at least one processor 902, where

the at least one memory 901 may be configured to store program code (a set of instructions); and

the at least one processor 902 may be in communication with the at least one memory 901. and configured to invoke the program code to perform the following operations:

in a process of changing a posture of the image capture device, obtaining a plurality of reference images captured by the image capture device;

performing saliency detection on each reference image to determine a salient region in each reference image;

determining an evaluation parameter(s) of each reference image based on the salient region in each reference image and a preset image composition rule;

determining a target image among the plurality of reference images based on the evaluation parameters; and

setting, based on a posture of the image capture device in capture of the target image, a posture of the image capture device in image capture.

In some exemplary embodiments, the at least one processor 902 may be configured to:

perform Fourier transform on the reference image;

obtain a phase spectrum of the reference image based on a first result of the Fourier transform; and

perform Gaussian filtering on a second result of inverse Fourier transform of the phase spectrum, to determine the salient region in the reference image.

In some exemplary embodiments, the preset image composition rule may include at least one image composition rule, and the at least one processor 902 may be configured to:

determine a first evaluation parameter(s) of the salient region in each reference image based on each image composition rule; and

perform weighted summation on the first evaluation parameter(s) corresponding to each image composition rule to determine the evaluation parameter(s) of the salient region based on the preset image composition rule.

In some exemplary embodiments, the image composition rule may include at least one of the following:

a rule of thirds, a subject visual balance method, a golden section method, or a center symmetry method.

In some exemplary embodiments, the image composition rule may include the rule of thirds, and the at least one processor 902 may be configured to:

determine a shortest distance among distances from coordinates of a center of the salient region to intersections of four trisectors in the reference image; and

calculate the first evaluation parameter(s) of the salient region with respect to the rule of thirds based on coordinates of a centroid of the salient region and the shortest distance.

In some exemplary embodiments, the image composition rule may include the subject visual balance method, and the at least one processor 902 may be configured to:

calculate a normalized Manhattan distance based on coordinates of a center of the reference image, and coordinates of a center and coordinates of a centroid of the salient region; and

calculate an evaluation parameter(s) of the salient region based on the subject visual balance method with the normalized Manhattan distance.

In some exemplary embodiments, the at least one processor 902 may be configured to:

before performing the saliency detection on each reference image, eliminate errors caused by lens distortion and a “jello” effect of the image capture device from the reference image.

In some exemplary embodiments, the at least one processor 902 may be configured to:

perform line-to-line synchronization between a vertical synchronization signal count value of the reference image and data of the reference image to determine motion information of each line of data in the reference image in an exposure process;

generate a grid in the reference image through backward mapping or forward mapping;

calculate the motion information by using an iterative method to determine an offset of coordinates at an intersection of the grid in the exposure process; and

de-distort (e.g., dewarp) the reference image based on the offset to eliminate the errors.

In some exemplary embodiments, the image capture control device may further include a gimbal, and the at least one processor 902 may be configured to:

set the posture of the image capture device in image capture by using the gimbal.

In some exemplary embodiments, the gimbal may include at least one of the following:

a single-axis gimbal, a two-axis gimbal, or a three-axis gimbal.

In some exemplary embodiments, a stabilization manner of the gimbal may include at least one of the following:

mechanical stabilization, electronic stabilization, or hybrid mechanical and electronic stabilization.

Some exemplary embodiments of the present disclosure further provide a mobile platform, including:

a body;

an image capture device, configured to capture an image; and

the image capture control device according to any one of the foregoing exemplary embodiments.

FIG. 10 is a schematic structural diagram of a mobile platform according to some exemplary embodiments of the present disclosure. As shown in FIG. 10, the mobile platform may be a handheld photographing apparatus, and the handheld photographing apparatus may include a lens 101, a three-axis gimbal, and an inertial measurement unit (IMU) 102. The three axes may be a pitch axis 103, a roll axis 104, and a yaw axis 105 respectively. The three-axis gimbal may be connected to the lens 101. The pitch axis may be configured to adjust a pitch angle of the lens, the roll axis may be configured to adjust a roll angle of the lens, and the yaw axis may be configured to adjust a yaw angle of the lens.

The inertial measurement unit 102 may be disposed below the back side of the lens 101. A pin(s) of the inertial measurement unit 102 may be connected to a vertical synchronization pin(s) of a photoelectric sensor to sample a posture of the photoelectric sensor. A sampling frequency may be set as needed, for example, may be set as 8 kHz, so that the posture and motion information of the lens 101 when obtaining a reference image may be recorded by sampling. Further, motion information of each line of pixels in the reference image may be inversely inferred based on the vertical synchronization signal. For example, the motion information may be determined according to step S51 in the exemplary embodiments shown in FIG. 7, so that the reference image may be de-distorted (e.g., dewarped).

The system, apparatus, module, or unit described in the foregoing exemplary embodiments may be specifically implemented by a computer chip or an entity, or implemented by a product having a function. For ease of description, when the foregoing apparatus is described, the functions are classified into different units for separate description. Certainly, when this disclosure is implemented, functions of all units may be implemented in one or more pieces of software and/or hardware. A person skilled in the art should understand that the embodiments of the present disclosure may be provided as a method, a system, or a computer program product. Therefore, the present disclosure may include a form of hardware only embodiments, software only embodiments, or embodiments with a combination of software and hardware. Moreover, the present disclosure may use a form of a computer program product that is implemented on one or more computer-usable storage media (including but not limited to a disk memory, a CD-ROM, an optical memory, and the like) that include computer-usable program code.

All embodiments in the present disclosure are described in a progressive manner. For the part that is the same or similar between different embodiments, reference may be made between the embodiments. Each embodiment focuses on differences from other embodiments. In particular, the system embodiment is basically similar to the method embodiment, and therefore is described briefly. For related information, refer to descriptions of the related parts in the method embodiment.

It should be noted that the relational terms such as first and second in this disclosure are used only to differentiate an entity or operation from another entity or operation, and do not require or imply any actual relationship or sequence between these entities or operations. The terms “comprising”, “including”, or any other variants thereof are intended to cover a non-exclusive inclusion, so that a process, a method, an article, or a device that includes a list of elements not only includes those elements but also includes other elements that are not expressly listed, or further includes elements inherent to the process, method, article, or device. In absence of further constraints, an element preceded by “includes a . . . ” does not preclude existence of other identical elements in the process, method, article, or device that includes the element.

The foregoing descriptions are merely some exemplary embodiments of this disclosure, and are not intended to limit this disclosure. For a person skilled in the art, this disclosure may have various changes and variations. Any modification, equivalent replacement, improvement, and the like made within the principle of this disclosure shall fall within the scope of the claims of this disclosure.

What is claimed is:

1. An image capture control method, comprising:
obtaining, in a posture changing process of an image capture device, a plurality of reference images captured by the image capture device;
for each of the plurality of reference images,
determining a salient region by performing saliency detection, and
determining at least one evaluation parameter based on the salient region and a preset image composition rule;
determining a target image among the plurality of reference images based on the at least one evaluation parameter of each of the plurality of reference images; and
setting, based on a first posture of the image capture device when capturing the target image, a second posture of the image capture device for capturing other images.

2. The method according to claim 1, wherein for each of the plurality of reference images, the determining of the salient region by performing the saliency detection includes:
performing Fourier transform on the reference image;
obtaining a phase spectrum of the reference image based on a first result of the Fourier transform; and
determining the salient region in each of the plurality of reference images by performing Gaussian filtering on a second result of inverse Fourier transform of the phase spectrum.

3. The method according to claim 1, wherein the preset image composition rule includes at least one image composition rule; and
for each of the plurality of reference images, the determining of the at least one evaluation parameter includes:
determining a first evaluation parameter of the salient region in the reference image based on each of the at least one image composition rule; and
determining the at least one evaluation parameter of the reference image by performing weighted summation on the first evaluation parameter corresponding to each of the at least one image composition rule.

4. The method according to claim 3, wherein the at least one image composition rule includes at least one of a rule of thirds, a subject visual balance method, a golden section method, or a center symmetry method.

5. The method according to claim 4, wherein the at least one image composition rule includes the rule of thirds, under which a reference image is imaginarily divides by two first trisection-lines along a length direction of the reference image and two second trisection-lines along a width direction of the reference image, forming four intersections; and
for each of the plurality of reference images, the determining of the first evaluation parameter of the salient region in the reference image based on each of the at least one image composition rule includes:
determining a shortest distance among distances from a center of the salient region to the four intersections, and
determining the first evaluation parameter of the salient region with respect to the rule of thirds based on coordinates of a centroid of the salient region and the shortest distance.

6. The method according to claim 4, wherein the at least one image composition rule includes the subject visual balance method; and
for each of the plurality of reference images, the determining of the first evaluation parameter of the salient region in the reference image based on each of the at least one image composition rule includes:
determining a normalized Manhattan distance based on coordinates of a center of the reference image, and coordinates of a center of the salient region, and coordinates of a centroid of the salient region; and
determining the first evaluation parameter of the salient region with respect to the subject visual balance method based on the normalized Manhattan distance.

7. The method according to claim 1, further comprising, prior to the performing of the saliency detection on each of the plurality of reference images:
eliminating errors caused by at least one of lens distortion or a “jello” effect of the image capture device from each of the plurality of reference images.

8. The method according to claim 7, wherein the eliminating of the errors caused by at least one of the lens distortion or the “jello” effect of the image capture device includes:
performing line-to-line synchronization on a vertical synchronization signal count value of each of the plurality of reference images and data of each of the plurality of reference images to determine motion information of each line of data in each of the plurality of reference images in an exposure process;
generating a grid in each of the plurality of reference images through backward mapping or forward mapping;
calculating the motion information by using an iterative method to determine an offset in coordinates at an intersection of the grid in the exposure process; and
de-distorting each of the plurality of reference images based on the offset to eliminate the errors.

9. The method according to claim 1, wherein the setting of the second posture of the image capture device for capturing images includes:
setting the second posture of the image capture device for capturing images by using a gimbal.

10. An image capture control device, comprising
at least one storage medium storing a set of instructions for image capture control; and
at least one processor in communication with the at least one storage medium, wherein during operation, the at least one processor executes the set of instructions to:
obtain, in a posture changing process of the image capture device, a plurality of reference images captured by the image capture device;
for each of the plurality of reference images:
determine a salient region by performing saliency detection;
determine at least one evaluation parameter based on the salient region and a preset image composition rule;
determine a target image among the plurality of reference images based on the at least one evaluation parameter of each of the plurality of reference images; and
set, based on a first posture of the image capture device in when capture capturing of the target image, a second posture of the image capture device in for capturing other images.

11. The image capture control device according to claim 10, wherein for each of the plurality of reference images, to determine the saliency region, the at least one processor executes the set of instructions to:
perform Fourier transform on the reference image;
obtain a phase spectrum of the reference image based on a first result of the Fourier transform; and
determine the salient region in each of the plurality of reference images by perform Gaussian filtering on a second result of inverse Fourier transform of the phase spectrum.

12. The image capture control device according to claim 10, wherein the preset image composition rule includes at least one image composition rule; and
for each of the plurality of reference images, to determine the at least one evaluation parameter, the at least one processor executes the set of instructions to:
determine a first evaluation parameter of the salient region in the reference image based on each of the at least one image composition rule; and
determine the at least one evaluation parameter of the reference image by perform weighted summation on the first evaluation parameter corresponding to each of the at least one image composition rule.

13. The image capture control device according to claim 12, wherein the at least one image composition rule includes at least one of a rule of thirds, a subject visual balance method, a golden section method, or a center symmetry method.

14. The image capture control device according to claim 13, wherein the at least one image composition rule includes the rule of thirds, under which a reference image is imaginarily divides by two first trisection-lines along a length direction of the reference image and two second trisection-lines along a width direction of the reference image, forming four intersections; and
for each of the plurality of reference images, to determine the first evaluation parameter of the salient region, the at least one processor executes the set of instructions to:
determine a shortest distance among distances from a center of the salient region to the four intersections, and
determine the first evaluation parameter of the salient region with respect to the rule of thirds based on coordinates of a centroid of the salient region and the shortest distance.

15. The image capture control device according to claim 13, wherein the at least one image composition rule includes the subject visual balance method; and
for each of the plurality of reference images, to determine the first evaluation parameter of the salient region, the at least one processor executes the set of instructions to:
determine a normalized Manhattan distance based on coordinates of a center of the reference image, and coordinates of a center of the salient region, and coordinates of a centroid of the salient region; and
determine the first evaluation parameter of the salient region with respect to the subject visual balance method based on the normalized Manhattan distance.

16. The image capture control device according to claim 10, wherein prior to perform the saliency detection on each of the plurality of reference images, the at least one processor further executes the set of instructions to:
eliminate errors caused by at least one of lens distortion or a “jello” effect of the image capture device from each of the plurality of reference images.

17. The image capture control device according to claim 16, wherein to eliminate the errors caused by at least one of the lens distortion or the “jello” effect of the image capture device, the at least one processor executes the set of instructions to:
perform line-to-line synchronization on a vertical synchronization signal count value of each of the plurality of reference images and data of each of the plurality of reference images to determine motion information of each line of data in each of the plurality of reference images in an exposure process;
generate a grid in each of the plurality of reference images through backward mapping or forward mapping;
calculate the motion information by using an iterative method to determine an offset in coordinates at an intersection of the grid in the exposure process; and
de-distort each of the plurality of reference images based on the offset to eliminate the errors.

18. The image capture control device according to claim 10, further comprising:
a gimbal,
wherein to set the second posture of the image capture device for capturing images, the at least one processor executes the set of instructions to:
set the second posture of the image capture device for capturing images by using the gimbal.

19. A mobile platform, comprising:
a body;
an image capture device to capture at least one image; and
an image capture control device, comprising:
at least one storage medium storing a set of instructions for image capture control; and
at least one processor in communication with the at least one storage medium, wherein during operation, the at least one processor executes the set of instructions to:
obtain, in a posture changing process of the image capture device, a plurality of reference images captured by the image capture device;
for each of the plurality of reference images,
determine a salient region by performing saliency detection;
determine at least one evaluation parameter based on the salient region and a preset image composition rule;
determine a target image among the plurality of reference images based on the at least one evaluation parameter of each of the plurality of reference images; and
set, based on a first posture of the image capture device in when capture capturing of the target image, a second posture of the image capture device in for capturing other images.

20. The mobile platform according to claim 19, wherein the mobile platform is an unmanned aerial vehicle, an unmanned vehicle, a handheld device, or a mobile robot.
